(19) United States
(12) Patent Application Publication
(10) Pub. No.: US 2021/0150432 A1
(43) Pub. Date: May 20, 2021

(54) RISK ASSESSMENT SYSTEM AND METHOD

(71) Applicant: GEOPULSE INC., San Francisco, CA (US)

(72) Inventors: Mark Y Rosenberg, San Francisco, CA (US); Dor Kelman, Hod Hasharon (IL)

(21) Appl. No.: 16/616,729

(22) PCT Filed: May 31, 2017
(86) PCT No.: PCT/US17/35149

§ 371 Date: Nov. 25, 2019

(51) Int. Cl. G06Q 10/06; G06F 16/2457; G06F 16/248; G06F 16/2455; G06F 16/28

(52) U.S. Cl. CPC G06Q 10/0635; G06F 16/24578; G06F 16/283; G06F 16/24556; G06F 16/248

(57) ABSTRACT

A risk assessment system and method are disclosed for deriving up-to-date risk scores. A structural database includes top-line scores, sub-dimension scores, and a conceptual framework for aggregating the sub-dimension scores to calculate the top-line score. A word scores dictionary includes keywords with associated word scores and sub-dimensions. A natural language processor receives, scrapes and classifies input events, and calculates suggested sub-dimension scores using keywords. For a selected event, a scoring widget enables a user to modify and/or accept the suggested sub-dimension scores. An assessment database includes current values for the top-line and sub-dimension scores. For each accepted sub-dimension score, an aggregation component aggregates the accepted sub-dimension score with the current value of that sub-dimension score, updates the current value of that sub-dimension score with the aggregated value, and updates the current values of any other sub-dimension scores and the top-line score that depend on the aggregated value.

### BACKGROUND

The world is changing more and more rapidly, and large amounts of information are continually being generated that capture and review current events. In addition, virtually instantaneous communication of “local” events across the globe can cause the “local” events to have international implications. Current methods of keeping up with current events are typically not effective at remaining up-to-date with, and understanding the implications of, the latest available information. One of many areas where this is the case is political risk analysis.

Political risk is a growing concern for industry leaders, and it is increasingly expected that geopolitical instability in one area can have an effect on global business. Concern has grown to the point that there are political risk insurance and consulting markets. Political risk assessment is typically performed by experts sifting through large amount of information. It takes time for the impacts of current events to be integrated into the assessments which only allows low frequency, weekly or monthly updates.

It would be desirable to have risk assessment systems that can integrate the inputs from various information sources into established models to generate high-frequency risk assessment updates, for example daily or more frequently.

### SUMMARY

The risk assessment system can be used for various applications, including for example country-level political risk assessment. The established structural data and the processing of new information source data can be tailored to the application. The risk assessment system can generate high-frequency (daily or near real-time), comprehensive risk measures. These measures can summarize the relative likelihood that an event will have an adverse impact. These measures can be customized to determine different types of risk on different outcomes. The risk assessment system can derive these measures and associated indicators from a structural database and the processed inputs from the current information sources. The structural database represents an established model for the application based on domain expertise with a conceptual framework that includes selected variables which can be combined and aggregated to derive the desired risk scores. Natural language processing of the inputs using keywords and machine learning can convert unstructured text data from the information sources into risk scores. The keyword scores for new inputs can be aggregated into event dimension scores that can be used to update the risk score and its contributing scores. The latest risk scores can be saved to a risk assessment database for display in graphs and other output formats.

A risk assessment system is disclosed for deriving up-to-date risk scores, where the risk assessment system includes a structural database, a word scores dictionary, an information source input, a natural language processor, a scoring widget, an assessment database, an aggregation component, and an output processor. The structural database includes a top-line dimension having a top-line score, a plurality of sub-dimensions having sub-dimension scores, and a conceptual framework for aggregating one or more of the sub-dimension scores to calculate the top-line score. The word scores dictionary includes a plurality of keywords, where each keyword has an associated word score and one or more associated sub-dimensions. The information source input is configured to receive input events from multiple input information sources. The natural language processor that, for each of the input events, scrapes the event, classifies the event, and for each keyword found in the event calculates a NLP suggested sub-dimension score for any sub-dimensions associated with the keyword based on the word score associated with the keyword. The scoring widget presents a list of events and, for a selected event, presents the NLP suggested sub-dimension scores for the selected event. The scoring widget also enables a user to modify any of the NLP suggested sub-dimension scores and to accept any of the NLP suggested sub-dimension scores. An accepted sub-dimension score is any of the modified or unmodified NLP suggested sub-dimension scores for the selected event accepted by the user. The assessment database includes current values for the top-line score and the plurality of sub-dimension scores. For each of the accepted sub-dimension scores, the aggregation component aggregates the accepted sub-dimension score from the scoring widget with the current value of that sub-dimension score in the assessment database and updates the current value of that sub-dimension score with the aggregated value. The aggregation component also updates the current values of any other sub-dimension scores and the top-line score in the assessment database that depend on the aggregated value. The output processor is configured to produce outputs using the assessment database.

Each accepted sub-dimension score can have an associated duration, where the impact of the accepted sub-dimension score is removed from the current value of that sub-dimension score in the assessment database when the associated duration ends for the accepted sub-dimension score. The associated duration for each accepted sub-dimension score can be selectable in the scoring widget. The time of the associated duration can begin when the sub-dimension score is accepted in the scoring widget. The impact of each accepted sub-dimension score can decay over time during the associated duration of the accepted sub-dimension score.

The current value of each score, for the top-line score and each sub-dimension score in the assessment database, can be calculated to equal the value of that score in the structural database plus the impact of any accepted sub-dimension score that is within its associated duration. The aggregation component can update the current values of the top-line score and the plurality of sub-dimension scores in the assessment database at near real-time to enable near real-time outputs and updates using the assessment database.

The natural language processor can identify various metadata in each event and classify each event based on the various metadata. The structural database can include multiple instances of the top-line score and the plurality of sub-dimension scores, where each instance corresponds to a different member of a class for which up-to-date risk scores are derived. The conceptual framework can be the same for aggregating the sub-dimension scores of each class to calculate the top-line score for that class. The natural language processor can classify each event into one or more of the different members of the class and each NLP suggested sub-dimension score can be for a particular member. The assessment database can include current values for the top-line score and the plurality of sub-dimension scores for each member of the class.

The NLP suggested sub-dimension score for the sub-dimension associated with the keyword found in the event can be a function of the ratio of the keywords in the event associated with the sub-dimension and the total words in the event.

The risk assessment system can also include a machine learning component that receives the outputs of the natural language processor including the NLP suggested sub-dimension scores, and receives the accepted sub-dimension scores from the scoring widget. The machine learning component can generate a process to calculate MLC suggested sub-dimension scores for future events based on the differences between the NLP suggested sub-dimension scores and the corresponding accepted sub-dimension scores.

A risk assessment method for deriving up-to-date risk scores is disclosed that includes organizing a structural database including a top-line dimension having a top-line score, a plurality of sub-dimensions having sub-dimension scores, and a conceptual framework for aggregating one or more of the sub-dimension scores to calculate the top-line score; creating a word scores dictionary comprising a plurality of keywords, each keyword of the plurality of keywords having an associated word score and one or more associated sub-dimensions; receiving a plurality of input events from a plurality of input information sources; for each event of the plurality of input events, scraping the event, classifying the event, and for each keyword found in the event calculating a NLP suggested sub-dimension scores for any sub-dimensions associated with the keyword based on the word score associated with the keyword; presenting a list of selectable events to a user; for a selected event of the list of selectable events, presenting the NLP suggested sub-dimension scores for the selected event, enabling the user to modify any of the NLP suggested sub-dimension scores and to accept any of the NLP suggested sub-dimension scores, where an accepted sub-dimension score is any of the modified or unmodified NLP suggested sub-dimension scores for the selected event accepted by the user; maintaining an assessment database including current values for the top-line score and the plurality of sub-dimension scores; for each of the accepted sub-dimension score, aggregating the accepted sub-dimension score with the current value of that sub-dimension score in the assessment database, updating the current value of that sub-dimension score with the aggregated value, and updating the current values of any other sub-dimension scores and the top-line score in the assessment database that depend on the aggregated value; and producing outputs using the assessment database.

Each accepted sub-dimension score can have an associated duration. The method can also include removing the impact of the accepted sub-dimension score from the current value of that sub-dimension score in the assessment database when the associated duration ends for the accepted sub-dimension score. The method can also include selecting the associated duration for each accepted sub-dimension score, and counting down time of the associated duration starting when the sub-dimension score is accepted. The method can also include decaying the impact of each accepted sub-dimension score over time during the associated duration of the accepted sub-dimension score.

The current value of each score, for the top-line score and each sub-dimension score in the assessment database can equal the value of that score in the structural database plus the impact of any accepted sub-dimension score that is within its associated duration. The method can also include updating the current values of the top-line score and the plurality of sub-dimension scores in the assessment database at near real-time to enable near real-time outputs and updates using the assessment database.

The method can also include identifying various metadata in each event; and classifying each event based on the various metadata. The structural database can include multiple instances of the top-line score and the plurality of sub-dimension scores, where each instance corresponds to a different member of a class for which up-to-date risk scores are derived. The conceptual framework can be the same for aggregating the sub-dimension scores of each class to calculate the top-line score for that class. The assessment database can include current values for the top-line score and the plurality of sub-dimension scores for each member of the class. The method can also include classifying each event into one or more of the different members of the class; and calculating each NLP suggested sub-dimension score for a particular member.

The step of calculating a NLP suggested sub-dimension scores for any sub-dimensions associated with the keyword in the event, can include calculating the NLP suggested sub-dimension score as a function of the ratio of the keywords in the event associated with the sub-dimension and the total words in the event.

The method can also include sending the NLP suggested sub-dimension scores to a machine learning component; sending the accepted sub-dimension scores to the machine learning component; and generating a process to calculate MLC suggested sub-dimension scores for future events based on differences between the NLP suggested sub-dimension scores and the corresponding accepted sub-dimension scores.

### BRIEF DESCRIPTION OF THE DRAWINGS

The above-mentioned aspects of the present invention and the manner of obtaining them will become more apparent and the invention itself will be better understood by reference to the following description of exemplary embodiments of the invention taken in conjunction with the accompanying drawings, wherein:

FIG. 1 illustrates a high level overview of an exemplary embodiment of a risk assessment system;

FIG. 2 illustrates an exemplary organization used in the structural database for a political risk assessment application;

FIG. 3 illustrates an excerpt from an exemplary word score dictionary for a political risk assessment application;

FIGS. 4A and 4B illustrate an exemplary event and score interface that can be used to pass information from the scoring widget to the aggregation component; and

FIG. 5 illustrates a possible computing environment for a risk assessment system comprising several computer systems coupled together through a network.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

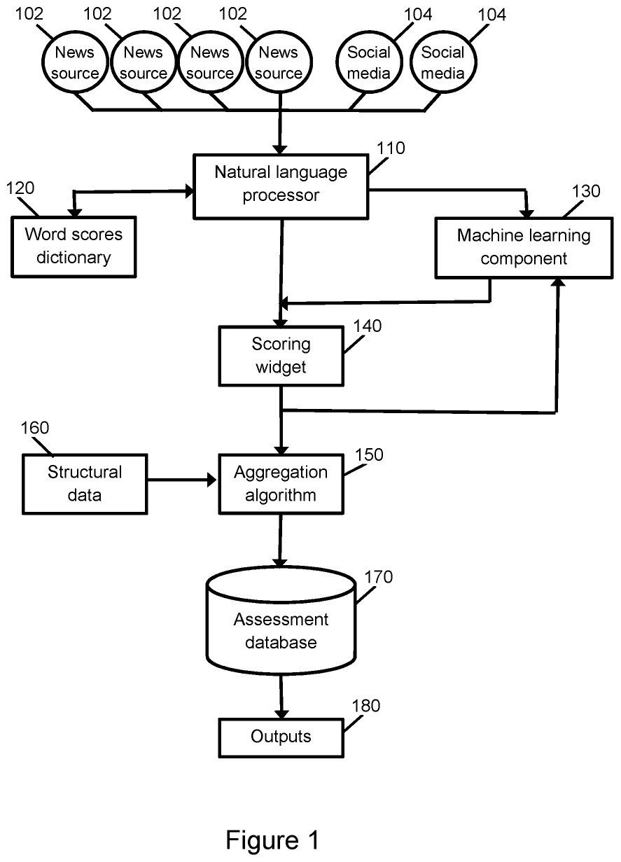

FIG. 1 illustrates a high level overview of an exemplary embodiment of a risk assessment system 100. The risk assessment system 100 receives news and other event information from a plurality of news sources 102 and a plurality of social media sites 104, and any of various other information sources available to the risk assessment system 100. These information sources can be accessible to the risk assessment system 100 over one or more local and wide-area networks. The information from the various information sources 102, 104 is input to a natural language processor 110. The natural language processor 110 sifts through, classifies and prioritizes the input data using a word scores dictionary 120. The word scores dictionary 120 includes a list of keywords and keyword combinations that have associated scores. The natural language processor 110 uses the word scores dictionary 120 to review the input data and calculate suggested scores based on the keywords and keyword combinations found in the data. The classified data output by the natural language processor 110 is sent to a machine learning component 130. The machine learning component 130 also reviews the classified data from the natural language processor 110 and calculates suggested scores. The machine learning component 130 can also have access to the word scores dictionary 120. The suggested scores from the natural language processor 110 and the machine learning component 130 are output to a scoring widget 140. The scoring widget 140 is used to review the suggested scores from the natural language processor 110 and the machine learning component 130 and derive unstructured scores for the classified data. The unstructured scores from the scoring widget 140 are input to an aggregation component 150 and fed back to the machine learning component 130. The machine learning component 130 can examine the differences between its earlier suggested scores for the classified data and the unstructured scores determined by the scoring widget 140 to learn what changes were made and revise its scoring methods for future suggested scores. The aggregation component 150 combines the unstructured scores from the scoring widget 140 with previously determined structured scores in a structural database 160. The combined scores determined by the aggregation component 150 are stored in a risk assessment database 170. The data in the risk assessment database 170 can be accessed to provide outputs and updates 180 which can include graphical, tabular and other data displays on computers and other electronic devices.

The risk assessment system 100 can be used for various applications, including for example country-level political risk assessment. The various components of the risk assessment system 100 are tailored to the application. The following description of the risk assessment system 100 will be for evaluating country-level political risk assessment, and those skilled in the art will understand how it can be applied in other areas.

When applied to country-level political risk assessment, the risk assessment system 100 can generate a high-frequency (more than daily), comprehensive measures of “political risk” at the country-level. These measures can summarize the relative likelihood that a political event will have an adverse impact on an investment or other economic outcomes. These measures can be customized to different types of investments or other economic outcomes. The risk assessment system 100 can derive these measures and associated indicators from the structural database 160 of country-level political risk and the processed inputs from the current information sources 102, 104. The structural database 160 represents a model of political risk at the country-level based on domain expertise in political economy, including a conceptual framework that includes selected variables which can be combined and aggregated to derive a country-level political risk score. The natural language processor 110, word score dictionary 120 and machine learning component 130 can convert unstructured text data from the information sources 102, 104 into political risk scores. The list of keywords and keyword combinations in the word score dictionary 120 can be developed by domain expertise in political economy. The keyword scores for an event can be calculated based on the word score dictionary 120, and these keyword scores can be aggregated into event dimension scores that can be used to update the political risk score and its contributing scores. The latest country-level political risk scores can be saved to the risk assessment database 170 for various outputs 180, including graphs, tables and other indicators and displays.

The risk assessment system 100 works primarily off of two data inputs, the inputs from the information sources 102, 104 and the structural database 160. For the case of country-level political risk assessment, the structural data 160 is built up using historical data and can be updated as often as desired by the system administrator, while the inputs from the information sources 102, 104 represents more recent data that is aggregated by the risk assessment system 100 with the structural data to generate current country-level risk values. The current country-level risk values can be stored in the risk assessment database 170 for updating of outputs 180.

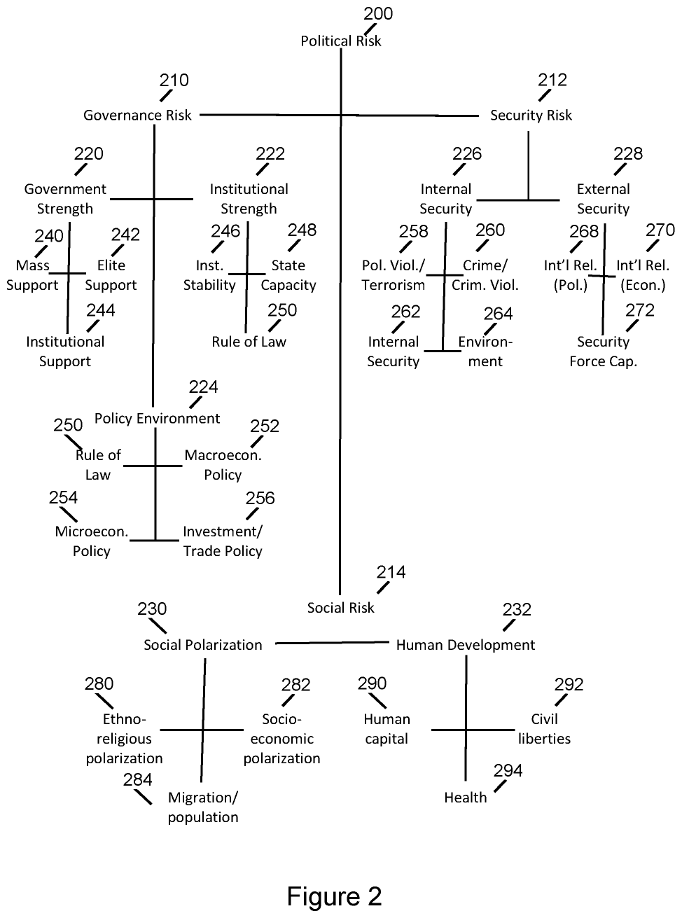

An exemplary organization and conceptual framework used in the structural database 160 for political risk assessment is shown in FIG. 2. In this case, structural database 160 includes multiple tiers of political risk dimensions with the top tier being the desired result of a country-level political risk score 200 for each country covered by the risk assessment system 100. The country-level political risk score 200 is determined based on second-tier dimension scores of a governance risk score 210, a security risk score 212 and a social risk score 214. The governance risk score 210 is determined based on third-tier dimension scores of a government strength score 220, an institutional strength score 222 and a policy environment score 224. The security risk score 212 is determined based on third-tier dimension scores of an internal security score 226, and an external security score 226. The social risk score 214 is determined based on third-tier dimension scores of a social polarization score 230, and a human development score 232. The government strength score 220 is determined based on fourth-tier dimension scores of a mass support score 240, an elite support score 242 and an institutional support score 244. The institutional strength score 222 is determined based on fourth-tier dimension scores of an institutional stability score 246, a state capacity score 248 and a rule of law score 250. The policy environment score 224 is determined based on fourth-tier dimension scores of the rule of law score 250, a macro-economic policy score 252, a micro-economic policy score 254 and an investment trade policy score 256. Similarly, the other higher-tier dimension scores can be determined based on lower-tier dimension scores. Note that some of the dimension scores can be used in the calculation of more than one higher-tier dimension score, for example the rule of law score 250 is used to calculate both the institutional strength score 222 and the policy environment score 224.

Each dimension of the structural database 160 can be populated with data drawn from multilateral institutions, governments, non-governments organizations, and the social science literature. Other data sources can also be used for this and other applications. For the country-level political risk structure shown in FIG. 2, the data and variable selection can be informed by domain expertise in political science using annual, country-level data and other information sources. Missing data for specific countries can be generated via multiple imputation algorithms. The data can be combined/aggregated using weighted rank aggregation algorithms to generate a ‘structural score’ for each dimension in the multi-tiered structure. The score for each lower-tier dimension feeds into another weighted rank aggregation algorithm which derives a dimension score for its respective higher-tier dimension. As such, the lower dimension scores for each country are aggregated up into the top-tier overall political risk score 200 for that country. In this example, the country-level political risk score 200 is the top-line indicator, while each lower-tier dimension score represents its own sub-indicator. The dimension scores can be grouped and aggregated into a range of other political risk indicators, including for example, political instability, social instability, terrorism risk, policy risk, etc. Similar structures to the one shown in FIG. 2 can be designed for derivation of these other political risk indicators from the dimension scores shown as well as others. The structure can include as many tiers and dimensions as desired to derive an acceptable estimate of the top-tier score. The various dimension scores and corresponding indicators, including the top-tier indicator, can be validated through regression analysis models on real-world economic and investment outcomes. The results of these validation tests can be used to help update and determine additional weights for integration in the rank aggregation algorithms used in deriving the higher-level dimension scores.

The dimension scores in the structural database 160 represents the estimates based on historical data and all available data up to the last update. The aggregation component 150 combines these structural scores with new values output by the scoring widget 140. These new values output by the scoring widget 140, “unstructured scores”, are derived from the information sources 102, 104. The news sources, social media and other information feeds provide information at a high-frequency, and the risk assessment system can generate current political risk indicators and outputs 180 in high-frequency, for example daily or at other desired intervals.

The natural language processor 110 scrapes news articles, social media posts, and other information sources from the Internet and any other data sources, and assigns each of them (“an event”) to specific countries. For each event, the natural language processor 110 produces a custom word cloud based on the word score dictionary 120, highlighting keywords according to their relative frequency in the text of that event. The natural language processor 110 identifies various metadata—including geographies, organizations and people—associated with each event. The natural language processor 110 also identifies the most frequent words in the event by part of speech. The natural language processor 110 identifies keywords and keyword combinations from the word score dictionary 120, and uses these identifications to suggest a list of event scores for the event.

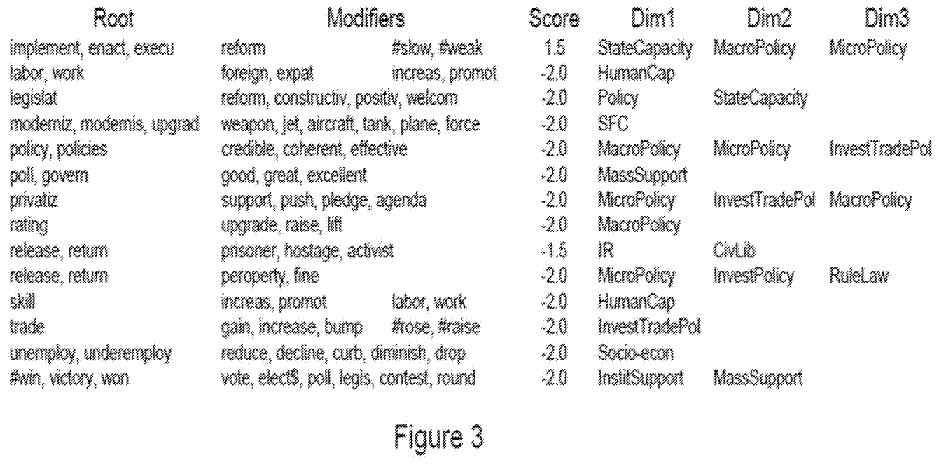

FIG. 3 shows an excerpt from an exemplary word score dictionary 120. The word scores dictionary 120 is a list of keywords and keyword combination, each of which is (i) assigned to one or more of the dimensions (for example, the dimensions shown in FIG. 2); and (ii) assigned a word score on symmetric positive/negative scale (i.e. a ‘word score’). A positive score indicates that the keyword(s) adds risk to the respective dimension, a negative score indicates that the keyword(s) reduces risk to the respective dimension. Initial values for word scores can be assigned by experts in the appropriate field, for example political science and political economy for political risk assessment. These word scores can be updated based on expert/analyst interaction with the scoring widget 140. The exemplary word scores dictionary 120 includes a plurality of rows where each row includes one or more root keywords, optional keyword modifiers, a word score, and one or more dimensions where that keyword combination is part of the aggregation in deriving the dimension score. Synonyms can be included in the same root keyword or modifier cell, separated by commas. For example, the first row of the word score dictionary 120 shown in FIG. 3 includes the root keywords “implement, enact, execute” with the modifier “reform”. Root words and modifiers in the word scores dictionary 120 can have natural language notations (for example, #, $, !, etc.) to indicate whether the natural language processor 110 should ignore or accept suffixes, prefixes or other keyword modifiers when scraping the input data 102, 104. Thus, when the natural language processor scrapes an event and finds the keyword combination “China enacts reform” then, when reviewed for China, one of the word score entries sent to the scoring widget 140 for the event will be a word score of 1.5 to be aggregated into the dimension scores for state capacity 248, macro-economic policy 252 and micro-economic policy 254. As an additional example, the third row of the word score dictionary 120 shown in FIG. 3 includes the root keyword “legislat” with the modifiers “reform, constructiv, positiv, welcome.” Thus, when the natural language processor scrapes an event and finds the keyword combination “Italy enacts constructive legislative reform” then, when reviewed for Italy, one of the word score entries sent to the scoring widget 140 for the event will be a word score of −2.0 to be aggregated into the dimension scores for the policy environment 224 and state capacity 248.

Each of the dimensions in the structural data shown in FIG. 2 is derived from an aggregation of keyword and keyword combinations known to the risk assessment system 100. Similar aggregation algorithms can be used by the scoring widget 140 to derive dimension scores for the events. In the example word score dictionary shown in FIG. 3, the keyword scores range from 3 to −3 corresponding to one of seven suggested impacts on the associated dimensions for the event being scored. These seven impacts can be considered: Very Positive (−3), Positive (−2), Slightly Positive (−1), Neutral (0), Slightly Negative (1), Negative (2), and Very Negative (3). Note that for this example of country-level political risk, positive impacts are indicated by negative values (lowering risk) and negative impacts are indicated by positive values (increasing risk). These suggested event scores for the affected dimensions are passed to the scoring widget 140.

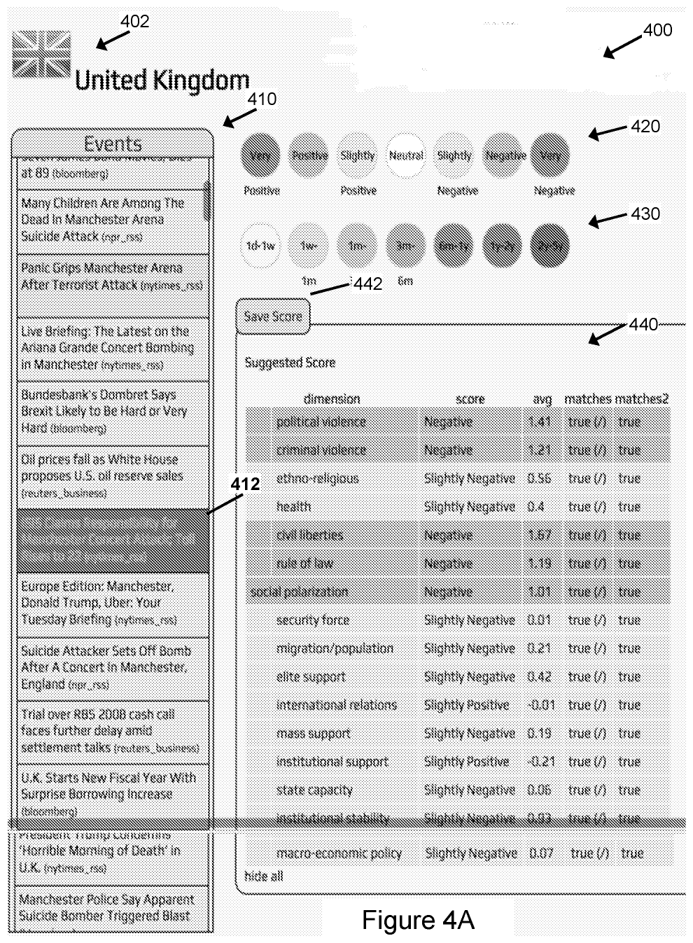

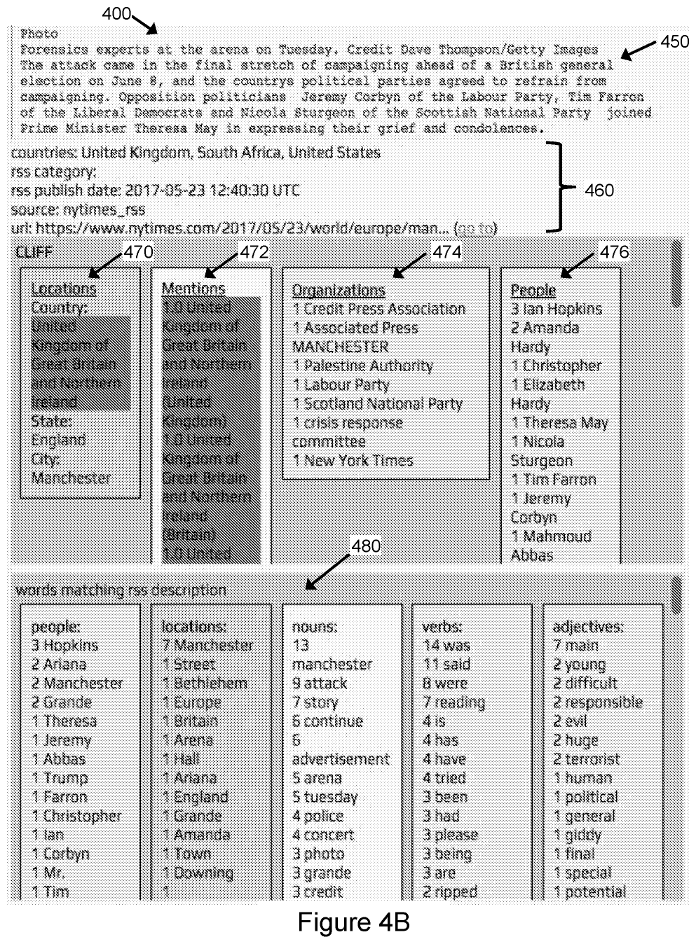

FIGS. 4A and 4B show an exemplary event and score interface 400 that can be used to pass information from the scoring widget 140 to the aggregation component 150. The event and score interface 400 includes a country identifier 402, an events table 410 for the identified country, a risk impact identifier 420, a duration selector 430, and an event dimension score table 440, the event article 450, an event summary 460, event location 470, locations mentioned 472, organizations mentioned 474, people mentioned 476, and lists of words 480 processed by the custom natural language processor 110 which include specific people and locations, nouns, verbs and adjectives lists. The events table 410 contains a list of events for the country identified by the country identifier 402. A user can select any of the events in the events table 410 and the system will display the event dimension score table 440, the event article 450, the event summary 460, the event location 470, the locations mentioned 472, the organizations mentioned 474, the people mentioned 476, and the lists of words 480 for the selected event in order of relevance. For the locations mentioned 472, the organizations mentioned 474, the people mentioned 476, and the lists of word matches 480, greater relevance can simply be determined by the greater number of occurrences. For the event dimension score table 440, relevance can be determined by a ratio of keyword occurrences impacting that dimension to the total number of words in the event, or by other measures desired by the user. FIGS. 4A and 4B show the results when event 412 is selected in the events table 410.

Selecting a suggested score in the event dimension score table 440 displays the current dimension score in the risk impact identifier 420, and the suggested impact duration for the event on the dimension in the duration selector 430. The risk impact identifier 420 shows the seven previously mentioned symmetrical risk values ranging from Very Positive (−3) to Very Negative (3). The duration selector 430 shows durations of dimension impact by the event of one day to one week, one week to one month, one to three months, three to six months, six months to one year, one to two years and two to five years. The duration options can be changed depending on the application or other requirements. When more than one dimension is selected in the event dimension score table 440, the risk impact identifier 420 and the duration selector 430 show the values for the last selected dimension. For example, the first entry in the event dimension score table 440 shows a suggested score for the selected event 412 for the political violence dimension 258 is a negative (greater than or equal to 1.0 and less than 2.0) event dimension score of −1.41. The suggested event dimension score for a dimension in the event dimension score table 440 can be calculated as a simple average of all keywords and keyword combinations and their associated scores for a particular dimension, or can be calculated by another desired aggregation process. The user can change the event dimension score by selecting a different risk value with the risk impact identifier 420 and/or can change the suggested impact duration for the event using the duration selector 430. Event duration impacts can have a default, for example one day to one week. A user can ‘accept’ the selected event dimension scores and durations in the event dimension score table 440 by clicking a ‘Save Score’ selector 442.

When the user selects the ‘Save Score’ selector 442, the event dimension scores and durations are sent to the aggregation component 150 and saved in the risk assessment database 170. These saved event dimension scores are combined with the existing dimension scores which include the structured dimension scores from the structural database 160 plus any previously saved event dimension scores that are still active (within their duration) for the relevant dimension. The event dimension scores remain ‘active’ for the extent of their associated duration. The event dimension scores can be calculated to decay over time according to a linear or other decay function over the course of their duration. After the event dimension scores are saved and integrated with the relevant existing dimension scores, all relevant higher dimension scores are updated and indicators are revised for display as graphs 180 and data 182.

The machine learning component 130 can monitor the deriving of the suggested event dimension scores by the natural language processor 110 and the revisions made by the user using the scoring widget 140. After sufficient monitoring, the machine learning component 130 can generate a separate list of suggested event dimension scores for consideration by the user in the scoring widget 140. These machine-learning suggested event dimension scores can be combined with or listed separately from the suggested event dimension scores from the natural language processor 110 in the event dimension score table 440.

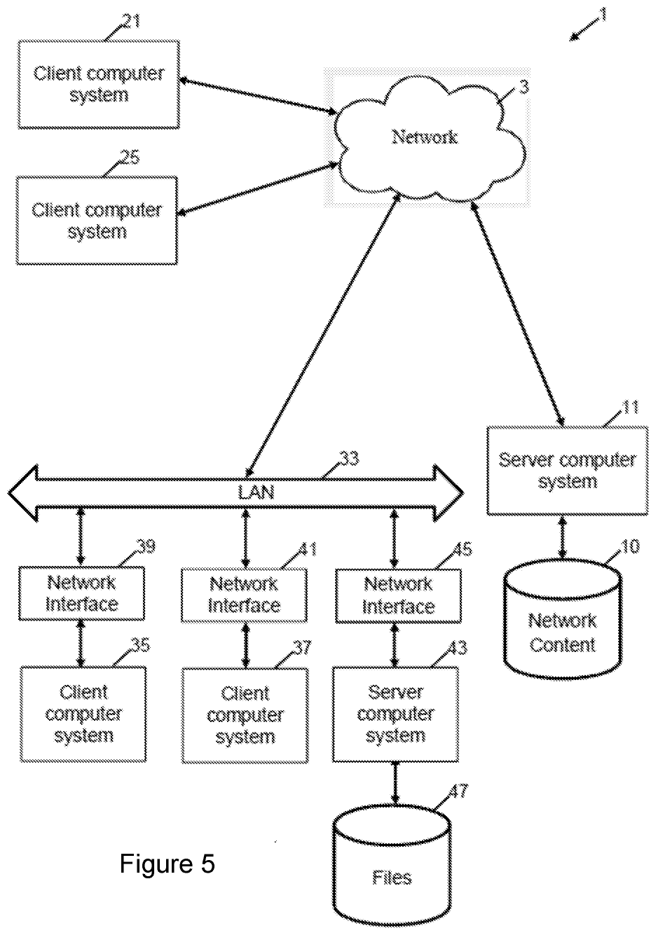

FIG. 5 is intended to provide an overview of computer hardware and other operating components suitable for the system and methods of the invention described herein. However, it is not intended to limit the applicable environments. One of skill in the art will immediately appreciate that the invention can be practiced with and interface with other computer system configurations, including hand-held devices, tablets, smart phones, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network, such as a local area network (LAN), wide-area network (WAN), or over the Internet.

FIG. 5 illustrates a possible computing environment for a risk assessment system comprising several computer systems 1 that are coupled together through a network 3, such as the Internet. Users on client systems, such as client computer systems 21, 25, 35, and 37 can be connected to the network 3 by various types of wired and wireless network interfaces. Access to the network 3 allows users of the client computer systems to exchange information, receive and send messages, and view documents, indicators and other outputs. These outputs can be stored in a network content database 10, which can include the assessment database 170, accessible through a server computer system 11 which is connected to the network 3.

Client computer systems 21, 25, 35, and 37 can each enable a user to view, create and modify information accessible over the network 3, as well as receive indicators and notifications. The client computer systems 21 and 25 can each be a personal computer system, a network computer, a smartphone, a tablet device, or other electronic device. Client computer systems 35 and 37 are coupled to a local area network (LAN) 33 through network interfaces 39 and 41, which can be Ethernet network or other network interfaces. A server computer system 43 can be directly coupled to the LAN 33 through a network interface 45 to provide files 47 and other services to the client computer systems 35 and 37, without the need to connect to the network 3. The risk assessment system 100 can be hosted on one or more of the client computer systems and/or server computer systems.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1. A risk assessment system for deriving up-to-date risk scores, the risk assessment system comprising:
a structural database that includes a top-line dimension having a top-line score, a plurality of sub-dimensions having sub-dimension scores, and a conceptual framework for aggregating one or more of the sub-dimension scores to calculate the top-line score;
a word scores dictionary that includes a plurality of keywords, each keyword of the plurality of keywords having an associated word score and one or more associated sub-dimensions;
an information source input configured to receive a plurality of input events from a plurality of input information sources;
a natural language processor (NLP) that for each event of the plurality of input events, is configured to scrape the event to find one or more event keywords of the plurality of keywords of the word scores dictionary, classify the event based on the one or more event keywords, and for each event keyword of the one or more event keywords found in the event calculate a NLP suggested sub-dimension score for any of the one or more associated sub-dimensions associated with the event keyword based on the word score associated with the event keyword;
a scoring widget configured to present a list of the events scored by the NLP and for a selected event from the list present the NLP suggested sub-dimension scores for the selected event, the scoring widget also configured to enable a user to modify any of the NLP suggested sub-dimension scores and to accept any of the NLP suggested sub-dimension scores, where an accepted sub-dimension score is any of the modified or unmodified NLP suggested sub-dimension scores for the selected event accepted by the user;
an assessment database that includes current values for the top-line score and the plurality of sub-dimension scores of the structural database;
an aggregation component that for each of the accepted sub-dimension scores, is configured to aggregate the accepted sub-dimension score from the scoring widget with the current value of that sub-dimension score in the assessment database to update the current value of that sub-dimension score in the assessment database with the aggregated value, the aggregation component also configured to update the current values of any other sub-dimension scores and the top-line score in the assessment database that depend on the updated current value of that sub-dimension score;
an output processor configured to produce outputs using the assessment database.

2. The risk assessment system of claim 1, wherein each accepted sub-dimension score has an associated duration, and an impact of the accepted sub-dimension score is removed from the updated current value of that sub-dimension score in the assessment database when the associated duration ends for the accepted sub-dimension score.

3. The risk assessment system of claim 2, wherein the associated duration for each accepted sub-dimension score is selectable in the scoring widget, and the time of the associated duration begins when the sub-dimension score is accepted in the scoring widget.

4. The risk assessment system of claim 3, wherein the impact of each accepted sub-dimension score decays over time during the associated duration of the accepted sub-dimension score.

5. The risk assessment system of claim 4, wherein the current value of each score, for the top-line score and each sub-dimension score in the assessment database, equals the value of that score in the structural database plus the impact of any accepted sub-dimension score that is within its associated duration.

6. The risk assessment system of claim 1, wherein the aggregation component updates the current values of the top-line score and the plurality of sub-dimension scores in the assessment database at near real-time to enable near real-time outputs and updates using the assessment database.

7. The risk assessment system of claim 1, wherein the natural language processor identifies various metadata in each event and classifies each event based on the various metadata.

8. The risk assessment system of claim 7, wherein the structural database includes multiple instances of the top-line score and the plurality of sub-dimension scores, each instance corresponding to a different member of a class for which up-to-date risk scores are derived, the conceptual framework being the same for aggregating the sub-dimension scores of each class to calculate the top-line score for that class;
wherein the natural language processor classifies each event into one or more of the different members of the class and each NLP suggested sub-dimension score is for a particular member; and
wherein the assessment database includes current values for the top-line score and the plurality of sub-dimension scores for each member of the class.

9. The risk assessment system of claim 1, wherein the NLP suggested sub-dimension score for the sub-dimension associated with the keyword found in the event is a function of the ratio of the keywords in the event associated with the sub-dimension and the total words in the event.

10. The risk assessment system of claim 1, further comprising a machine learning component (MLC) that receives the outputs of the natural language processor including the NLP suggested sub-dimension scores, receives the accepted sub-dimension scores from the scoring widget; and, based on differences between the NLP suggested sub-dimension scores and the corresponding accepted sub-dimension scores, generates a process to calculate MLC suggested sub-dimension scores for future events.

11. A risk assessment method for deriving up-to-date risk scores, the risk assessment method comprising:
organizing a structural database including a top-line dimension having a top-line score, a plurality of sub-dimensions having sub-dimension scores, and a conceptual framework for aggregating one or more of the sub-dimension scores to calculate the top-line score;
creating a word scores dictionary comprising a plurality of keywords, each keyword of the plurality of keywords having an associated word score and one or more associated sub-dimensions;
receiving a plurality of input events from a plurality of input information sources;
for each event of the plurality of input events, scraping the event to find one or more event keywords of the plurality of keywords of the word scores dictionary, classifying the event based on the one or more event keywords, and each event keyword of the one or more event keywords found in the event calculating a NLP suggested sub-dimension scores for any of the one or more associated sub-dimensions associated with the event keyword based on the word score associated with the event keyword;
presenting a list of selectable events to a user;
for a selected event of the list of selectable events, presenting the NLP suggested sub-dimension scores for the selected event, enabling the user to modify any of the NLP suggested sub-dimension scores and to accept any of the NLP suggested sub-dimension scores, where an accepted sub-dimension score is any of the modified or unmodified NLP suggested sub-dimension scores for the selected event accepted by the user;
maintaining an assessment database including current values for the top-line score and the plurality of sub-dimension scores of the structural database;
for each of the accepted sub-dimension scores, aggregating the accepted sub-dimension score with the current value of that sub-dimension score in the assessment database, updating the current value of that sub-dimension score in the assessment database with the aggregated value, and updating the current values of any other sub-dimension scores and the top-line score in the assessment database that depend on the updated current value of that sub-dimension score;
producing outputs using the assessment database.

12. The risk assessment method of claim 11, wherein each accepted sub-dimension score has an associated duration, the method further comprising:
removing an impact of the accepted sub-dimension score from the updated current value of that sub-dimension score in the assessment database when the associated duration ends for the accepted sub-dimension score.

13. The risk assessment method of claim 12, further comprising:
selecting the associated duration for each accepted sub-dimension score, and
counting down time of the associated duration starting when the sub-dimension score is accepted.

14. The risk assessment method of claim 13, further comprising:
decaying the impact of each accepted sub-dimension score over time during the associated duration of the accepted sub-dimension score.

15. The risk assessment method of claim 14, wherein the current value of each score, for the top-line score and each sub-dimension score in the assessment database, equals the value of that score in the structural database plus the impact of any accepted sub-dimension score that is within its associated duration.

16. The risk assessment method of claim 11, further comprising:
updating the current values of the top-line score and the plurality of sub-dimension scores in the assessment database at near real-time to enable near real-time outputs and updates using the assessment database.

17. The risk assessment method of claim 11, further comprising:
identifying various metadata in each event; and
classifying each event based on the various metadata.

18. The risk assessment method of claim 17, wherein the structural database includes multiple instances of the top-line score and the plurality of sub-dimension scores, each instance corresponding to a different member of a class for which up-to-date risk scores are derived, the conceptual framework being the same for aggregating the sub-dimension scores of each class to calculate the top-line score for that class;
wherein the assessment database includes current values for the top-line score and the plurality of sub-dimension scores for each member of the class; and the method further comprises:
classifying each event into one or more of the different members of the class;
calculating each NLP suggested sub-dimension score for a particular member.

19. The risk assessment method of claim 11, wherein calculating a NLP suggested sub-dimension scores for any sub-dimensions associated with the keyword in the event comprises:
calculating the NLP suggested sub-dimension score as a function of the ratio of the keywords in the event associated with the sub-dimension and the total words in the event.

20. The risk assessment method of claim 11, further comprising:
sending the NLP suggested sub-dimension scores to a machine learning component;
sending the accepted sub-dimension scores to the machine learning component; and
generating a process to calculate MLC suggested sub-dimension scores for future events based on differences between the NLP suggested sub-dimension scores and the corresponding accepted sub-dimension scores.

21. The risk assessment system of claim 8, wherein the class is countries of the world, each member of the class is a particular country, and for each particular country the top-line dimension is a country-level political risk score for the particular country.
